(19) United States
(12) Patent Application Publication
(10) Pub. No.: US 2022/0166094 A1
(43) Pub. Date: May 26, 2022

(54) BATTERY AND PRODUCTION METHOD THEREFOR

(71) Applicant: Panasonic Intellectual Property Management Co., Ltd., Osaka (JP)

(72) Inventors: HIDEYUKI UEDA, Osaka (JP); SUGURU MATSUMURA, Osaka (JP)

(21) Appl. No.: 17/440,224

(22) PCT Filed: Jan. 27, 2020
(86) PCT No.: PCT/JP2020/002822

§ 371 Date: Sep. 17, 2021

(30) Foreign Application Priority Data
Mar. 29, 2019 (JP) 2019-068753

(51) Int. Cl. H01M 50/171; H01M 10/0587; H01M 50/152

(52) U.S. Cl. CPC H01M 50/171; H01M 50/152; H01M 10/0587

(57) ABSTRACT

A battery comprising: a case having an opening at one end and a bottom at the other end. The case including a cylindrical side surface, an electrode group accommodated in the case together with an electrolytic solution, a cap that seals the opening of the case, and a gasket disposed between the opening of the case and the cap. The case includes an annular groove protruding inward of the case in a part of the cylindrical side surface. The gasket includes a seal accommodating the cap and a cylindrical part extending from the seal toward the electrode group. The cylindrical part of the gasket and a deepest groove of the case have portions in contact with each other, and a contact of the gasket is compressed by the deepest groove of the case.

### TECHNICAL FIELD

The present invention relates to a battery and a production method for the same, and more particularly to a sealed battery using a cylindrical case and a production method for the same.

### BACKGROUND ART

In recent years, there has been significant progress in improvement in performance and reduction in size and weight of portable devices such as mobile phones and mobile terminals, and wearable devices such as medical wristband terminals, smart glasses, wireless earphones, and stylus pens. A power source of such an electronic device is desired to be a small and high-capacity battery. Usually, such a battery adopts a structure that an opening portion of a battery case accommodating an electrode group is caulked and sealed with a cap via a gasket.

For these small sealed batteries, various improvements have been made on the battery case and the gasket for the purpose of improving the sealed state and preventing damage to the electrode group.

For example, PTL 1 describes that a creepage distance of a contact surface between a battery can and a seal packing is increased by axially compressing the seal packing having a radius of curvature larger than a radius of curvature of a sealing groove portion of the battery can in order to solve a technical problem of sealing by caulking a battery case.

In addition, PTL 2 describes that an annular gasket in which a seal portion and a cylindrical part are integrated is used to prevent an electrode group from greatly vibrating at the time of battery vibration and avoid damage to the electrode group at the time of manufacturing a battery.

### CITATION LIST

### Patent Literature

PTL 1: Unexamined Japanese Patent Publication No. 1-248455

PTL 2: WO 2017/017930 A

### SUMMARY OF THE INVENTION

However, although the sealed battery described in PTL 1 increases the creepage distance of the contact surface between the groove portion of the battery can and the seal packing, when the groove portion is formed deeper for this purpose, the pressure at the time of forming the groove is excessively applied to the groove portion and the gasket around the groove portion, and the groove portion and the gasket may be cracked or split. In addition, the electrolytic solution may leak from the crack or split portion generated in the groove portion or the gasket, and there has been a problem that the sealability of the battery sealing portion is deteriorated.

On the other hand, in the battery described in PTL 2, the inner diameter of the case groove portion is designed to be sufficiently larger than the outer diameter of the cylindrical part of the gasket in order to facilitate the attachment work of the gasket (see paragraph [0039] of PTL 2). Therefore, after the electrolytic solution is injected, the electrolytic solution may enter a gap between the case inner peripheral surface and the gasket, particularly a gap between the case inner peripheral surface and the gasket from the case groove portion to the opening portion. As a result, at the time of sealing by caulking, the infiltrated electrolytic solution may adhere to the vicinity of the battery sealing portion or the upper portion of the case, and battery contamination may occur.

When the battery is stored for a long period of time, the electrolytic solution remaining in the gap between the case inner peripheral surface and the gasket may ooze out, and the oozed out electrolytic solution may be deposited (white stain) as an electrolyte.

Such contamination damages the aesthetic appearance of a battery as a product, and a large amount of leakage of an electrolytic solution deteriorates battery characteristics and damages the reliability of the battery. In addition, if the leaked electrolytic solution adheres to the battery manufacturing equipment and contaminates the equipment, it may lead to defective assembly of the battery.

The present invention has been made to solve such problems, and provides a battery and a production method of the same, which can suppress the presence of an electrolytic solution in a gap between an inner peripheral surface of a battery case and a gasket in a battery sealing portion and can prevent leakage of the electrolytic solution from the sealing portion at the time of manufacturing the battery or at the time of storing the battery.

A first aspect of the present invention relates to a battery including: a case having an opening portion at one end and a bottom portion at the other end, the case including a cylindrical side surface portion; an electrode group accommodated in the case together with an electrolytic solution; a cap that seals the opening portion of the case; and a gasket disposed between the opening portion of the case and the cap, wherein the case includes an annular groove portion protruding inward of the case in a part of the cylindrical side surface portion, the gasket includes a seal portion accommodating the cap and a cylindrical part extending from the seal portion toward the electrode group, a cylindrical part of the gasket and a deepest groove portion of the case have portions in contact with each other, and a contact portion of the gasket is compressed by the deepest groove portion of the case.

A second aspect of the present invention relates to a production method of a battery, including: accommodating an electrode group in a case having an opening portion at one end and a bottom portion at other end and having a cylindrical side surface portion; forming an annular groove portion protruding inward of the case in a part of a cylindrical side surface portion of the case; inserting a gasket, the gasket including a seal portion accommodating a cap and a cylindrical part extending from the seal portion, into the groove portion of the case to compress the cylindrical part of the gasket at a groove deepest portion of the case; injecting an electrolytic solution into the case; and sealing the opening portion of the case and the cap with a seal portion of the gasket interposed therebetween.

In the battery and the production method of the same of the present invention, since the cylindrical part of the gasket is inserted in a state of being compressed by the deepest groove portion of the case, it is possible to suppress liquid leakage of the electrolytic solution from the gap between the gasket and the case. This makes it possible to prevent battery staining and white staining due to leakage of the electrolytic solution.

### BRIEF DESCRIPTION OF DRAWINGS

FIG. 1 is a longitudinal sectional view of a battery according to the present exemplary embodiment.

FIG. 2 (a) is a longitudinal sectional view of a cap, (b) is a longitudinal sectional view of a gasket, and (c) is a longitudinal sectional view of a main part illustrating an opening portion and a groove portion of a battery case.

FIG. 3 (a) is a bottom view of the gasket, and (b) is a plan view of a battery case after grooving.

### DESCRIPTION OF EMBODIMENT

Exemplary embodiments of a battery according to the present invention and a production method of the same will be described below with reference to the accompanying drawings. The terms used in the text do not limit the present invention, and shapes and dimensions of the components in the drawings are also illustrated as relative ones, and do not limit the present invention.

### (Overall Configuration of Battery)

First, an overall configuration of a battery 1 according to the present exemplary embodiment will be described below.

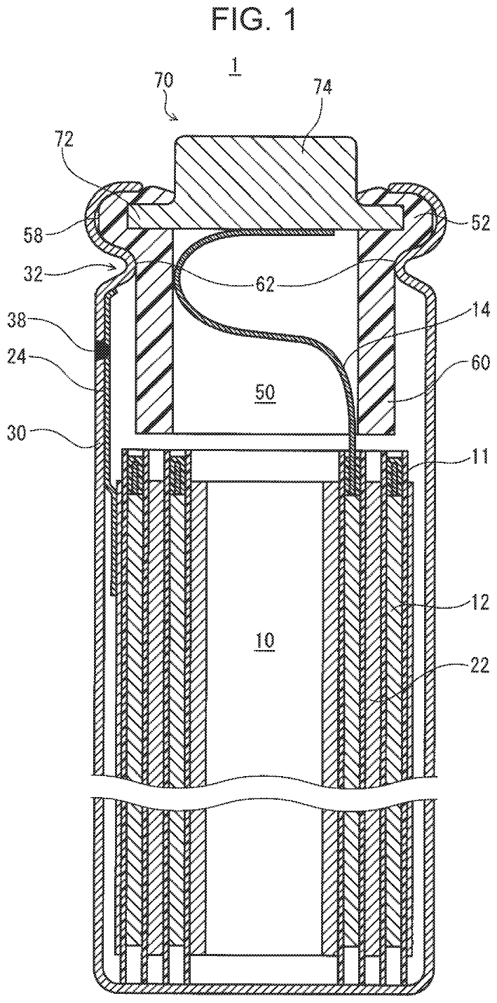

FIG. 1 is a longitudinal sectional view of the battery 1 according to the present exemplary embodiment. Battery 1 illustrated in FIG. 1 includes electrode group 10 formed by winding first electrode (for example, a positive electrode) 12 and second electrode (for example, a negative electrode) 22 with separator 11 interposed therebetween, battery case 30 having annular groove portion 32, gasket 50 disposed in an opening portion of battery case 30, an electrolytic solution (not illustrated) housed in battery case 30, and cap 70 that seals the opening portion of gasket 50. Next, each component will be described below.

### (Electrode Group)

Electrode group 10 is configured as a columnar body by winding first electrode 12 and second electrode 22 with separator 11 interposed therebetween. First electrode 12 has a first current collector sheet and first active material layers formed on both sides thereof (both not illustrated). Second electrode 22 also has a second current collector sheet and second active material layers formed on both sides thereof (both not illustrated). First electrode 12 is connected to conductive cap 70 via first current collector lead 14. On the other hand, second electrode 22 is connected to the inner peripheral surface near the opening of conductive battery case 30 through second current collector lead 24. Here, cap 70 functions as a first terminal (for example, a positive electrode terminal) of battery 1, and battery case 30 functions as a second terminal (for example, a negative electrode terminal) of battery 1.

A case where first electrode 12 and second electrode 22 are the positive electrode and the negative electrode, respectively, will be described in more detail.

Positive electrode 12 has a positive electrode current collector sheet and positive electrode active material layers formed on both sides thereof (not illustrated). A known positive electrode current collector sheet can be used as the positive electrode current collector sheet, but when the battery is a lithium ion secondary battery, for example, a metal foil such as aluminum or an aluminum alloy is used, and the thickness thereof is, for example, 10 μm to 20 μm, but is not limited thereto.

The positive electrode active material layer contains a positive electrode active material as an essential component, and contains a binder, a conductive agent, and the like as optional components. As the positive electrode active material, a known active material can be used, but as the positive electrode active material of the lithium ion secondary battery, a lithium-containing composite oxide is preferable, and for example, LiCoO₂, LiNiO₂, LiMn₂O₄, or the like is used. As the positive electrode active material of the lithium primary battery, manganese dioxide, graphite fluoride, or the like is used. The thickness of the positive electrode active material layer is, for example, 70 μm to 130 μm, but is not limited thereto.

For positive electrode current collector lead 14 of the lithium ion secondary battery, for example, a material such as aluminum, an aluminum alloy, nickel, a nickel alloy, iron, or stainless steel can be used. The thickness is, for example, 10 μm to 120 μm, but is not limited thereto. Positive electrode current collector lead 14 passes through the hollow portion of cylindrical part 60 of gasket 50 and is connected to the bottom surface of cap 70 also serving as a positive electrode terminal.

Negative electrode 22 includes a negative electrode current collector sheet and negative electrode active material layers formed on both sides thereof (not illustrated). A known negative electrode current collector sheet can be used as the negative electrode current collector sheet, but when the battery is a lithium ion secondary battery, for example, a metal foil such as stainless steel, nickel, copper, or a copper alloy is used. The thickness is, for example, 5 μm to 20 μm, but is not limited thereto.

The negative electrode active material layer contains a negative electrode active material as an essential component, and contains a binder, a conductive agent, and the like as optional components. As the negative electrode active material, a known negative electrode active material can be used, but when the battery is a lithium ion secondary battery, for example, metal lithium, an alloy such as a silicon alloy or a tin alloy, a carbon material such as graphite or hard carbon, a silicon compound, a tin compound, lithium titanate, or the like is used. The thickness of the negative electrode active material layer is, for example, 70 μm to 150 μm, but is not limited thereto.

For example, a material such as nickel, a nickel alloy, iron, stainless steel, copper, or a copper alloy can be used for negative electrode current collector lead 24 of the lithium ion secondary battery. The thickness may be, for example, 10 μm to 120 μm, but is not limited thereto. Negative electrode current collector lead 24 is connected to an inner surface of the case side wall in the vicinity of the opening of battery case 30 (connection position 38 is illustrated).

A known separator can be used as separator 11 disposed between positive electrode 12 and negative electrode 22, and is formed using an insulating microporous thin film, a woven fabric, or a nonwoven fabric. As the separator of the lithium ion secondary battery, for example, polyolefin such as polypropylene or polyethylene can be used. The thickness is 10 μm to 50 μm, preferably 10 μm to 30 μm.

### (Electrolytic Solution)

As the electrolytic solution, a known electrolytic solution can be used. In the case of a lithium ion secondary battery, the lithium ion secondary battery is composed of a known lithium salt and a known nonaqueous solvent. For example, as the nonaqueous solvent, a cyclic carbonate ester, a chain carbonate ester, a cyclic carboxylate ester, or the like is used, and as the lithium salt, for example, LiPF₆, LiBF₄, or the like is used, but the nonaqueous solvent and the lithium salt are not limited thereto.

### (Battery Case)

Battery case 30 illustrated in FIG. 1 has a cylindrical shape, and has an opening at one end and a bottom portion for closing the opening portion at the other end. Annular groove portion 32 is formed near the opening portion of battery case 30. Annular groove portion 32 protrudes into battery case 30. Battery case 30 may have an elliptical columnar shape in addition to a cylindrical shape as long as it has a tube shape.

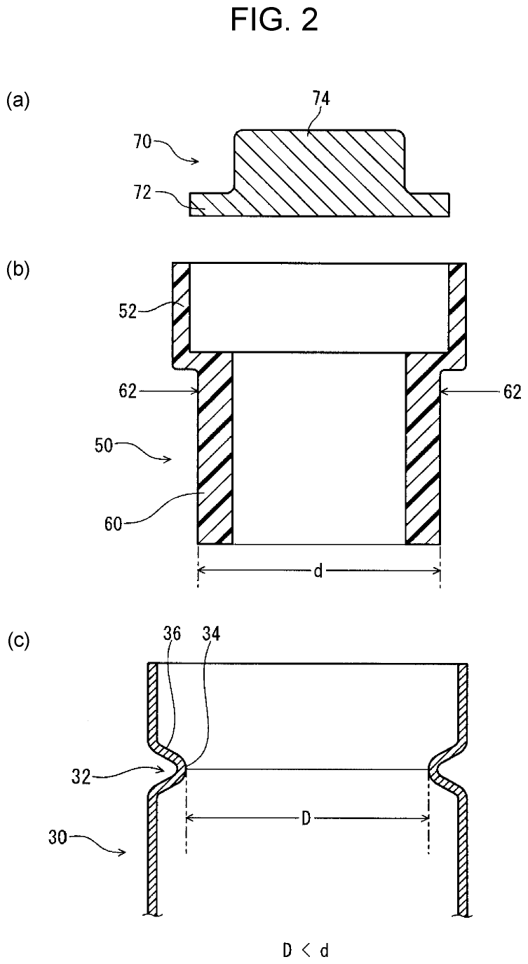

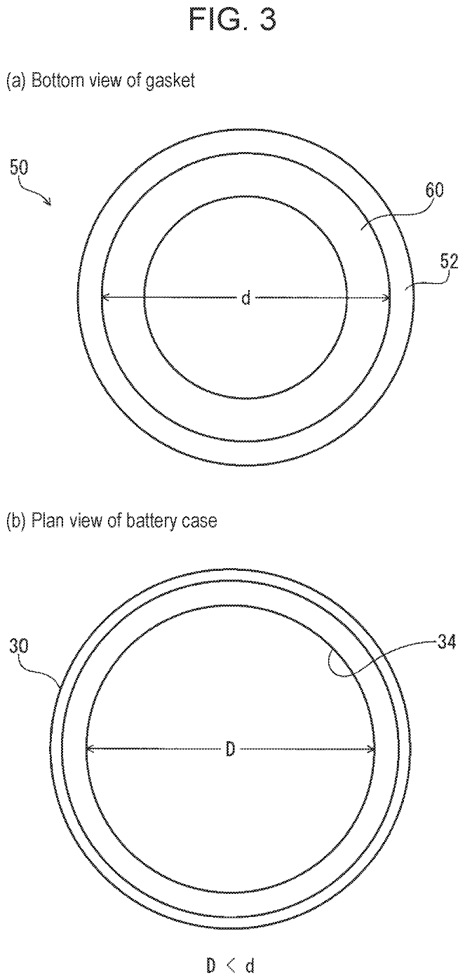

FIG. 2 is a sectional view of battery case 30, gasket 50, and cap 70 constituting a sealed portion of battery 1 in a state before battery 1 is assembled. FIG. 3 shows a bottom view of gasket 50 and a plan view of battery case 30.

As illustrated in FIGS. 2(c) and 3(b), in battery case 30, annular groove portion 32 protruding inward of the case is formed in a part of a case side surface. Annular groove portion 32 includes deepest groove portion 34 protruding most and diameter-reduced portion 36 extending from the side surface of battery case 30 toward deepest groove portion 34. That is, as illustrated in FIGS. 1 and 2(c), the diameter of diameter-reduced portion 36 is configured to gradually decrease.

Deepest groove portion 34 of annular groove portion 32 is designed to have a circular shape with a diameter of dimension D. Battery case 30 is made of a material having conductivity, and stainless steel having a thickness of, for example, 0.05 mm to 0.2 mm is used, but is not limited thereto.

### (Gasket and Cap)

Gasket 50 has seal portion 52 for accommodating cap 70 and cylindrical part 60 extending from seal portion 52 toward electrode group 10 accommodated in battery case 30. On the other hand, seal portion 52 includes a flat support portion that supports the lower surface of flange 72 of cap 70 and a holding portion that holds the upper surface of the flange. As described above, cylindrical part 60 of gasket 50 has a structure extending from the flat support portion of seal portion 52 of gasket 50 toward electrode group 10 accommodated in battery case 30.

Cylindrical part 60 of the gasket functions as a spacer that provides a space between cap 70 and electrode group 10. By integrating seal portion 52 and cylindrical part 60 of gasket 50 and providing a space portion corresponding to the height of the cylindrical part between cap 70 and electrode group 10, welding between negative electrode current collector lead 24 and the side surface of battery case 30 can be facilitated, and electrode group 10 can be prevented from moving or vibrating during use or transportation of the battery.

The effectiveness of gasket 50 having the shape of the present invention increases as the outer diameter of battery case 30 decreases, and specifically, the outer diameter of the battery case is preferably 10 mm or less, more preferably 6 mm or less, and still more preferably 4.5 mm or less. The outer diameter of battery case 30 is preferably 3 mm or more in consideration of manufacturing reality.

As illustrated in FIG. 2(a), cap 70 has flange 72 extending radially outward of cap 70 and terminal portion 74 protruding upward at the center thereof, and these are integrally formed of a conductive material. Flange 72 of cap 70 is held by seal portion 52 of gasket 50. As described above, seal portion 52 of gasket 50 accommodates cap 70, and seal portion 52 of gasket 50 is crimped together with the opening portion of battery case 30 to seal battery 1.

In the present invention, when gasket 50 is inserted from the opening portion of battery case 30, cylindrical part 60 of gasket 50 is inserted so as to be compressed by deepest groove portion 34 of the case. As a result, cylindrical part 60 of gasket 50 and deepest groove portion 34 of the case are in close contact with each other. Contact portion 62 is preferably continuously in close contact with deepest groove portion 34 of battery case 30 by a line or a plane along the circumference. As illustrated in FIG. 3(a), gasket 50 is designed such that an outer peripheral surface of contact portion 62 has a circular shape having a diameter of dimension d on a surface radially inward through contact portion 62 between deepest groove portion 34 and cylindrical part 60.

In FIGS. 1 and 2(b), cylindrical part 60 of gasket 50 is illustrated to extend parallel to the side surface of battery case 30, but may have a slightly tapered funnel shape as long as the outer peripheral surface of contact portion 62 has a circular shape with diameter d.

Gasket 50 is preferably formed of a material having resistance to an electrolytic solution, and for example, a fluororesin, polyolefin, polyamide, or the like is preferably used. Among them, a fluororesin is more preferably used, and for example, a copolymer (PFA) of tetrafluoroethylene and perfluoroalkoxy vinyl ether is preferably used.

Battery 1 according to the present exemplary embodiment is configured such that inner diameter D of deepest groove portion 34 of annular groove portion 32 is smaller than outer diameter d of the cylindrical part abutting on deepest groove portion 34. That is, since gasket 50 is inserted into battery case 30 in a state where cylindrical part 60 is compressed by deepest groove portion 34, a gap between deepest groove portion 34 and contact portion 62 of cylindrical part 60 can be eliminated. Therefore, it is possible to prevent the electrolytic solution stored in battery case 30 from leaking through groove portion 32.

More specifically, the difference (D−d) between inner diameter D of deepest groove portion 34 and outer diameter d of cylindrical part 60 is preferably −0.01 to −0.20 mm. The ratio (D/d) of inner diameter D of deepest groove portion 34 to outer diameter d of cylindrical part 60 is preferably 0.93 to 0.99. Furthermore, the compression ratio (1−D/d) obtained by dividing the difference between inner diameter D of deepest groove portion 34 and outer diameter d of cylindrical part 60 by outer diameter d of cylindrical part 60 is preferably 0.1% to 7.5%, and more preferably 1% to 6%. This makes it possible to more reliably prevent liquid leakage through groove portion 32.

In addition, battery case 30 has been described above as being designed such that the side peripheral surface of deepest groove portion 34 has a perfect circular shape with inner diameter D. However, since the outer diameter of battery case 30 is small, it is not easy to process deepest groove portion 34 to have a perfect circular shape. However, when deepest groove portion 34 does not have a perfect circular shape but has a sectional shape approximate to a perfect circle, it is preferable to set a value (hereinafter, it is defined as a strain rate) obtained by dividing a difference (Dmax−Dtrue) between maximum inner diameter Dmax and diameter Dtrue of a perfect circle inscribed in the sectional shape approximate to a perfect circle by diameter Dtrue of a perfect circle to 0.01 or less, and this can more effectively prevent liquid leakage through groove portion 32. On the other hand, when the strain rate exceeds 0.02, the electrolytic solution may be substantially reduced.

In addition, even when gap 58 is generated at the boundary between seal portion 52 of gasket 50 and battery case 30, cylindrical part 60 of gasket 50 is inserted in a state of being compressed by deepest groove portion 34 of annular groove portion 32, whereby cylindrical part 60 and deepest groove portion 34 are continuously brought into close contact with each other in a linear shape or a planar shape, and liquid leakage of the electrolytic solution can be prevented.

As described above, according to the present exemplary embodiment, inner diameter D of deepest groove portion 34 of battery case 30 is designed to be smaller than outer diameter d of the cylindrical part abutting on deepest groove portion 34, so that it is possible to prevent the electrolytic solution from oozing out through annular groove portion 32. Therefore, it is possible to solve the problem of battery contamination caused by leakage of the electrolytic solution in the vicinity of the sealed portion or the upper portion of the case at the time of sealing by caulking and white contamination caused by oozing out of the electrolytic solution remaining in the sealed portion at the time of long-term storage. As a result, it is possible to realize a battery having high reliability while securing the aesthetic appearance of the battery as a product without causing shortage of the amount of the electrolytic solution. In addition, it is also possible to reduce assembly failure caused by contamination due to transfer of the leaked electrolytic solution to a peripheral mass production facility.

### (Production Method of Battery)

Next, a production method of battery according to the present exemplary embodiment will be described below.

First, electrode group 10 described above is prepared. Electrode group 10 is inserted into battery case 30 through the opening portion such that negative electrode current collector lead 24 and positive electrode current collector lead 14 of electrode group 10 extend toward the opening portion of battery case 30 (upward in the drawing). Negative electrode current collector lead 24 is welded to the side peripheral surface of battery case 30 at the connection position 38. Then, annular groove portion 32 is formed near an end forming the opening portion of battery case 30.

Gasket 50 is then inserted into battery case 30 through the opening portion. At this time, since inner diameter D of deepest groove portion 34 of annular groove portion 32 is designed to be smaller than outer diameter d of the gasket cylindrical part abutting on deepest groove portion 34, gasket 50 is inserted in a state where cylindrical part 60 is compressed by deepest groove portion 34 of annular groove portion 32.

Positive electrode current collector lead 14 is drawn out from the hollow portion of cylindrical part 60 and welded to cap 70. Cylindrical part 60 of gasket 50 extends deeply toward electrode group 10, and cylindrical part 60 is interposed between negative electrode current collector lead 24 and positive electrode current collector lead 14, so that contact between the current collector leads is avoided.

Next, an electrolytic solution is injected into battery case 30 by a vacuum injection method. At this time, as described above, a part of cylindrical part 60 of gasket 50 is already inserted in the compressed state by deepest groove portion 34 before the electrolytic solution is injected, and cylindrical part 60 and deepest groove portion 34 are in close contact with each other without a gap. Therefore, the electrolytic solution does not enter the inside surface of the case located above annular groove portion 32 during the electrolytic solution injection.

As described above, in the production method of the present invention, the electrolytic solution does not exist in the gap between the inside surface of the case located above the groove portion and the gasket facing the inside surface of the case, and it is possible to prevent the electrolytic solution from leaking from this portion during long-term storage of the battery or the like.

In addition, since cylindrical part 60 of gasket 50 and deepest groove portion 34 of case 30 are in close contact with each other, it is possible to prevent the electrolytic solution from leaking upward from deepest groove portion 34 even when the electrolytic solution stored in battery case 30 flows up.

Next, cap 70 is housed in seal portion 52, and finally, the opening portion of battery case 30 is caulked with cap 70 via gasket 50, whereby cylindrical battery 1 is obtained.

As described above, inner diameter D of deepest groove portion 34 of battery case 30 is designed to be smaller than outer diameter d of cylindrical part 60 at the portion abutting on deepest groove portion 34, and cylindrical part 60 is inserted in a state where cylindrical part 60 is compressed by deepest groove portion 34 of annular groove portion 32, whereby cylindrical part 60 of gasket 50 is continuously in close contact with deepest groove portion 34 of battery case 30 in a linear or planar shape. Therefore, even when gap 58 is generated at the boundary between seal portion 52 of gasket 50 and battery case 30, liquid leakage of the electrolytic solution can be prevented.

Note that the measurement of inner diameter D of deepest groove portion 34 of battery case 30, outer diameter d of cylindrical part 60 at the portion in contact with deepest groove portion 34, the strain rate, and the confirmation of battery contamination and white contamination can be performed, for example, using a digital microscope (VHF-700F) manufactured by Keyence Corporation.

### EXAMPLES

Batteries 1 according to a plurality of examples and comparative examples prepared by inserting gaskets 50 having different outer diameters d of cylindrical part 60 into battery case 30 in which inner diameter D (<d) of deepest groove portion 34 is constant are compared in the following manner.

Inner diameter D of deepest groove portion 34 of battery case 30 used in first to fifth examples and first to third comparative examples is 3.60 mm, and the target strain rate with respect to the perfect circle is 1% or less. Inner diameter D of deepest groove portion 34 of battery case 30 used in a fourth comparative example is 3.67 mm, and the target strain rate with respect to the perfect circle is 2% or more.

Further, outer diameters d of cylindrical part 60 at the portions where cylindrical part 60 and deepest groove portion 34 abut on each other used in the first to fifth examples are 3.69 mm, 3.73 mm, 3.65 mm, 3.85 mm, and 4.00 mm, respectively, and outer diameters d used in the first to fourth comparative examples are 3.57 mm, 3.55 mm, 3.50 mm, and 3.55 mm, respectively.

Batteries 1 according to the first to fifth examples and the first to fourth comparative examples have been evaluated for the following items. The evaluation results are illustrated in Table 1. In the first to fifth examples, inner diameter D is smaller than outer diameter d, and in the first to fourth comparative examples, inner diameter D is larger than outer diameter d.

TABLE 1

| | Outer diameter | Inner diameter D of | Press-fitting | Press-fitting | Compression ratio |
|---|---|---|---|---|---|
| | d of Cylindrical | Deepest groove portion | degree (D−d) | ratio (D/d) | (1−D/d) |
| | part 3.65~3.73 mm | 1% or less of Strain rate | −0.01 to −0.20 | 0.93 to 0.99 | 0.1 to 7.5% |
| First example | 3.69 mm | 3.60 mm | −0.09 mm | 0.98 | 2.4% |
| Second example | 3.73 mm | 3.60 mm | −0.13 mm | 0.97 | 3.5% |
| Third example | 3.65 mm | 3.60 mm | −0.05 mm | 0.99 | 1.4% |
| Fourth example | 3.85 mm | 3.60 mm | −0.25 mm | 0.94 | 6.5% |
| Fifth example | 4.00 mm | 3.60 mm | −0.40 mm | 0.90 | 10.0% |
| First comparative | 3.57 mm | 3.60 mm | 0.03 mm | 1.01 | −0.8% |
| example | | | | | |
| Second comparative | 3.55 mm | 3.60 mm | 0.05 mm | 1.01 | −1.4% |
| example | | | | | |
| Third comparative | 3.50 mm | 3.60 mm | 0.10 mm | 1.03 | −2.9% |
| example | | | | | |
| Fourth comparative | 3.55 mm | 3.67 mm | 0.12 mm | 1.03 | −3.4% |
| example | | | | | |
| | | Evaluation | | | |
| | | | | Liquid leakage | Liquid leakage |
| | | Reduced amount of | Battery contamination | resistance | resistance |
| | | Electrolytic solution (mg) | (white contamination) | vaccum inspection | Heat cycle |
| | First example | 0.38 | ○ | ○ | ○ |
| | Second example | 0.22 | ○ | ○ | ○ |
| | Third example | 0.45 | ○ | ○ | ○ |
| | Fourth example | 1.14 | ○ | ○ | Δ |
| | Fifth example | 1.32 | ○ | Δ | Δ |
| | First comparative | 1.82 | × | Δ | Δ |
| | example | | | | |
| | Second comparative | 2.03 | × | Δ | Δ |
| | example | | | | |
| | Third comparative | 3.52 | × | Δ | × |
| | example | | | | |
| | Fourth comparative | 5.41 | × | × | × |
| | example | | | | |

### 1) Amount of Decrease in Electrolytic Solution (Number of Samples: N=50)

The weight (W1) of the battery before injection, the weight (W2) of the battery after injection, and the weight (W3) of the battery after sealing are each measured, and the amount of decrease in the electrolytic solution is calculated from the following equation.

(Weight after injection−Weight before injection)−(Weight after sealing−Weight before injection)=(W2−W1)−(W3−W1)=W2−W3

In the evaluation table of Table 1, the average value of the total number of 50 samples is illustrated. In the evaluation table of Table 1, the electrolytic solution decrease amounts in the first to fifth examples are substantially smaller than the electrolytic solution decrease amounts in the first to fourth comparative examples.

### 2) Battery Contamination (Sample Number: N=50)

Sealed battery 1 is observed with a microscope from the upper part and the side surface of battery 1 to evaluate the presence or absence of adhesion of the electrolytic solution. In the evaluation table of Table 1, ∘ mark is illustrated when adhesion of the electrolytic solution is not confirmed for the total number of 50 samples, and x mark is illustrated when adhesion of the electrolytic solution is confirmed even for one sample. In the evaluation table of Table 1, battery contamination is not observed in the first to fifth examples, and battery contamination is observed in the first to fourth comparative examples.

### 3) Liquid Leakage Resistance-White Stain by Vacuum Inspection (Number of Samples: N=50)

Predetermined initial charge, high-temperature aging, and charge/discharge are sequentially performed on sealed battery 1 to adjust the charge rate (SoC) to 30%, and then the presence or absence of liquid leakage (liquid leakage inspection) is evaluated under a reduced pressure environment. In the liquid leakage inspection, battery 1 is left for 15 minutes under a reduced pressure environment of about −70 kPa, and then the presence or absence of liquid leakage from the sealed portion is evaluated. In the evaluation table of Table 1, ∘ is marked when liquid leakage is not observed by microscope observation with respect to the total number of 50 samples, Δ is marked when liquid leakage is observed in at least one sample by microscope observation but liquid leakage is not visually observed, and x is marked when liquid leakage is observed in at least one sample by visual observation. In the evaluation table of Table 1, liquid leakage is observed by microscope observation in the fifth example, but liquid leakage is not observed visually in the first to fifth examples, and liquid leakage is observed visually in the first to fourth comparative examples.

### 4) Liquid Leakage Resistance-Heat Cycle (Number of Samples: N=50)

Predetermined initial charge, high-temperature aging, and charge/discharge are sequentially performed on the sealed battery 1 to adjust the charge rate (SoC) to 100%, and then a heat cycle test is performed under the following environment to evaluate the presence or absence of liquid leakage (white stain). That is, in the heat cycle test, i) after storing at −10° C. for 1 hour, the temperature is raised to 60° C. over 1 hour, and stored at 60° C. for 1 hour, ii) after lowering the temperature to −10° C. over 1 hour, and stored for 1 hour, and iii) after repeating 1000 cycles of the steps i) and ii) as 1 cycle (required time: 4 hours), the presence or absence of liquid leakage from the sealed portion is evaluated. In the evaluation table of Table 1, ∘ is marked when liquid leakage is not observed by microscope observation with respect to the total number of 50 samples, Δ is marked when liquid leakage is observed in at least one sample by microscope observation but liquid leakage is not visually observed, and x is marked when liquid leakage is observed in at least one sample by visual observation. In the evaluation table of Table 1, liquid leakage is observed by microscope observation in the fourth and fifth examples, but liquid leakage is not observed visually in the first to fifth examples, and liquid leakage is observed visually in the first to fourth comparative examples.

### 5) Transfer Dirt of Electrolytic Solution to Mass Production Equipment

Microscope observation is performed on the sealing jig to evaluate the presence or absence of adhesion of the electrolytic solution. Although not illustrated in the evaluation table of Table 1, adhesion of the electrolytic solution to the sealing jig is not recognized in the first to fifth examples, but adhesion of the electrolytic solution to the sealing jig occurs in the first to fourth comparative examples, and increase in defects in the sealing step is recognized.

From the above evaluation, inner diameter D of deepest groove portion 34 of battery case 30 is designed to be smaller than outer diameter d of cylindrical part 60 at the portion abutting on deepest groove portion 34, and cylindrical part 60 is inserted in a state of being compressed by deepest groove portion 34 of annular groove portion 32, whereby cylindrical part 60 of gasket 50 is brought into a state of being continuously in close contact with deepest groove portion 34 of battery case 30 in a linear or planar shape, and thus, it is possible to prevent battery contamination and white contamination due to leakage of the electrolytic solution.

### INDUSTRIAL APPLICABILITY

The present invention can be applied to a sealed battery using a cylindrical case and a production method of the same.

### REFERENCE MARKS IN THE DRAWINGS

1 battery
10 electrode group
11 separator
12 first electrode
14 positive electrode current collector lead
22 second electrode
24 negative electrode current collector lead
30 battery case
32 groove portion
34 deepest groove portion
36 diameter-reduced portion
38 connection position
50 gasket
52 seal portion
58 gap
60 cylindrical part
62 contact portion
70 cap
72 flange
74 terminal portion

1. A battery comprising:
a case including an opening at one end and a bottom at another end, the case including a cylindrical side surface;
an electrode group accommodated in the case together with an electrolytic solution;
a cap that seals the opening of the case; and
a gasket disposed between the opening of the case and the cap,
wherein
the case includes an annular groove protruding inward of the case in a part of the cylindrical side surface,
the gasket includes a seal accommodating the cap and a cylindrical part extending from the seal toward the electrode group,
a contact part of the cylindrical part of the gasket and a contact part of a deepest groove of the case are in contact with each other, and
the contact part of the gasket is compressed by the deepest groove of the case.

2. The battery according to claim 1, wherein the contact part of the cylindrical part of the gasket and the contact part of the deepest groove of the case are in contact with each other is continuously in close contact in a linear or planar shape.

3. The battery according to claim 1, wherein a gap substantially exists between the seal of the gasket and the cylindrical side surface of the case facing this.

4. The battery according to claim 1, wherein in the contact part where the cylindrical part of the gasket and the deepest groove of the case are in contact with each other, an inner diameter of the deepest groove portion is denoted by D, an outer diameter of the cylindrical portion is denoted by d and D−d which is a difference between the inner diameter D and the outer diameter d is −0.01 mm to −0.20 mm.

5. The battery according to claim 1, wherein D/d which is a ratio of the inner diameter D of the deepest groove of the case to the outer diameter d of the cylindrical part of the gasket is 0.93 to 0.99.

6. The battery according to claim 1, wherein a compression ratio of the cylindrical part of the gasket is 0.1% to 7.5%.

7. The battery according to claim 1, wherein the deepest groove of the case includes a perfect circular shape in a cross section extending radially inward of the case.

8. The battery according to claim 1, wherein the deepest groove of the case includes a shape approximate to a perfect circle in a cross section extending radially inward of the case, and Dmax/Dtrue−1 which is a value obtained by dividing a difference between a maximum inner diameter Dmax and a diameter Dtrue of a perfect circle inscribed in the perfect circle approximate shape by the diameter Dtrue of the perfect circle is 0.01 or less.

9. The battery according to claim 1, wherein the electrode group is configured by winding a first electrode and a second electrode with a separator interposed between the first electrode and the second electrode including different polarities.

10. The battery according to claim 1, wherein an outer diameter of the cylindrical side surface of the case is 10 mm or less.

11. A production method of a battery, comprising:
accommodating an electrode group in a case including an opening at one end and a bottom at another end and including a cylindrical side surface;
forming an annular groove protruding inward of the case in a part of a cylindrical side surface of the case;
inserting a gasket, the gasket including a seal accommodating a cap and a cylindrical part extending from the seal, into the groove of the case to compress the cylindrical part of the gasket at a deepest groove of the case;
injecting an electrolytic solution into the case; and
sealing the opening of the case and the cap with a seal of the gasket interposed between the opening of the case and the cap.

12. The production method of a battery according to claim 11, wherein a contact part where the cylindrical part of the gasket and the deepest groove of the case are in contact with each other is continuously in close contact in a linear or planar shape.

13. The production method of a battery according to claim 11, wherein a gap substantially exists between the seal of the gasket and the cylindrical side surface of the case facing this.

14. The production method of a battery according to claim 11, wherein in the contact part where the cylindrical part of the gasket and the deepest groove of the case are in contact with each other, an inner diameter of the deepest groove portion is denoted by D, an outer diameter of the cylindrical portion is denoted by d and D−d which is a difference between the inner diameter D and the outer diameter d is −0.01 mm to −0.20 mm.

15. The production method of a battery according to claim 11, wherein D/d which is a ratio of the inner diameter D of the deepest groove of the case to the outer diameter d of the cylindrical part of the gasket is 0.93 to 0.99.

16. The production method of a battery according to claim 11, wherein a compression ratio of the cylindrical part of the gasket is 0.1% to 7.5%.

17. The production method of a battery according to claim 11, wherein the deepest groove of the case includes a perfect circular shape in a cross section extending radially inward of the case.

18. The production method of a battery according to claim 11, wherein the deepest groove of the case includes a shape approximate to a perfect circle in a cross section extending radially inward of the case, and Dmax/Dtrue−1 which is a value obtained by dividing a difference between a maximum inner diameter Dmax and a diameter Dtrue of a perfect circle inscribed in the perfect circle approximate shape by the diameter Dtrue of the perfect circle is 0.01 or less.

19. The production method of a battery according to claim 11, wherein the electrode group is configured by winding a first electrode and a second electrode with a separator interposed between the first electrode and the second electrode including different polarities.

20. The production method of a battery according to claim 11, wherein an outer diameter of the cylindrical side surface of the case is 10 mm or less.
